(19) United States
(12) Patent Application Publication
(10) Pub. No.: US 2016/0156614 A1
(43) Pub. Date: Jun. 2, 2016

(54) PROVISIONING A DEVICE OVER AN INTERNET OF THINGS

(71) Applicant: HCL Technologies Limited, Noida (IN)

(72) Inventors: Parveen Kumar JAIN, Noida (IN); Dhanyamraju S U M PRASAD, Hyderabad (IN)

(73) Assignee: HCL Technologies Limited, Noida (IN)

(21) Appl. No.: 14/951,535

(22) Filed: Nov. 25, 2015

(30) Foreign Application Priority Data
Nov. 28, 2014 (IN) 3467/DEL/2014

(51) Int. Cl. H04L 29/06; H04L 29/08

(52) U.S. Cl. CPC H04L 63/083; H04L 67/1042

(57) ABSTRACT

Disclosed is a method and system for provisioning a device over an Internet of Things (IoT) platform for establishing a bidirectional communication between the device and a system (IoT server). The system may identify a device based on device identification (ID) of the device. The system may further determine whether the device is communicating with the system for the first time or has previously communicated with the system. The system may automatically generate a username and a password for the device for authenticating the user. Post generating the username and the password, the system may transmit the username and the password to the device and an external device. Further, the external device may provide a connection between the device and other devices connected over the IoT based on the username and the password. The device may also create a buddy list by storing the usernames of the other devices.

### CROSS-REFERENCE TO RELATED APPLICATIONS AND PRIORITY

The present application claims benefit from Indian Complete Patent Application No. 3467/DEL/2014, filed on Nov. 28, 2014, the entirety of which is hereby incorporated by reference.

### TECHNICAL FIELD

The present subject matter described herein, in general, relates to automatically identifying a device over an Internet of Things (IoT) and providing services to the device.

### BACKGROUND

Internet of Things (IoT) refers to an interconnection of devices connected over the Internet. Almost any device comprising a communication unit may be connected over the IoT. The communication unit may enable a connection of the device over the IoT. The devices may be uniquely identifiable over the Internet. Further, the devices may be connected over the Internet using different topologies and protocols. The devices may be controlled by users operating user devices registered over the IoT.

Several challenges come along while developing the IoT using the devices. A few of the existing challenges are being explained further. For example, a challenge of identification of a device over the IoT may be need to be dealt with efficiently. Each of the devices connected over the IoT may not have a similar type of device identification. For example, each of the devices connected over the IoT may not have an Internet Protocol (IP) address. Another challenge faced during development of the IoT is a registration of the devices over the IoT. Specifically, the devices are generally registered manually over the IoT. Manually registering the devices over the IoT consumes a lot of time and effort. Yet another challenge faced during development of the IoT is related to privacy and security of data transferred over the IoT. The data transferred by the devices connected over the IoT may not be secure. Thus, the existing challenges faced while development of the IoT needs to be resolved.

### SUMMARY

This summary is provided to introduce aspects related to systems and methods for provisioning a device over an Internet of Things (IoT) platform and the aspects are further described below in the detailed description. This summary is not intended to identify essential features of the claimed subject matter nor is it intended for use in determining or limiting the scope of the claimed subject matter.

In one implementation, a method for provisioning a device over an Internet of Things (IoT) platform is disclosed. The method may comprise receiving a connection request and a device identification (ID) from a device. The method may comprise determining whether the device ID is pre-stored in an IoT database. The method may further comprise automatically generating a username and a random string as a password for the device based upon the device ID when the device ID is absent from the IoT database. The username and the password may be generated without a user input. The method may further comprise transmitting the username and the password to the device and to an external device. The method may further comprise facilitating the device for establishing a communication with the IoT platform based on the username and the password, thereby provisioning the device over the Internet of Things (IoT) platform.

In one implementation, a method for provisioning a device over an Internet of Things (IoT) platform is disclosed. The method may comprise receiving a connection request and a device identification (ID) from a device. The method may comprise determining whether the device ID is pre-stored in an IoT database. The method may further comprise automatically generating a new random string as a new password for the device when the username of the device ID is present in the IoT database. The new password may be generated without a user input. The method may further comprise transmitting the username and the new password to the device and to an external device. The method may further comprise facilitating the device for establishing a communication with the IoT platform based on the username and the new password, thereby provisioning the device over the Internet of Things (IoT) platform.

In one implementation, a system provisioning a device over an Internet of Things (IoT) platform is disclosed. The system comprises a processor and a memory coupled to the processor for executing programmed instructions stored in the memory. The processor may receive a connection request and a device identification (ID) from a device. The processor may further determine whether the device ID is pre-stored in an IoT database. The processor may further automatically generate a username and a random string as a password for the device based upon the device ID when the device ID is absent from the IoT database. The username and the password may be generated without a user input. The processor may further transmit the username and the password to the device and to an external device. The processor may further facilitate the device for establishing a communication with the IoT platform based on the username and the password, thereby provisioning the device over the Internet of Things (IoT) platform.

In one implementation, a system provisioning a device over an Internet of Things (IoT) platform is disclosed. The system comprises a processor and a memory coupled to the processor for executing programmed instructions stored in the memory. The processor may receive a connection request and a device identification (ID) from a device. The processor may further determine whether the device ID is pre-stored in an IoT database. The processor may further automatically generate a new random string as a new password for the device when the username of the device ID is present in the IoT database. The new password may be generated without a user input. The processor may further transmit the username and the new password to the device and to an external device. The processor may further facilitate the device for establishing a communication with the IoT platform based on the username and the new password, thereby provisioning the device over the Internet of Things (IoT) platform.

In one implementation, a non-transitory computer readable medium embodying a program executable in a computing device for provisioning a device over an Internet of Things (IoT) platform is disclosed. The program may comprise a program code for receiving a connection request and a device identification (ID) from a device. The program may further comprise a program code for determining whether the device ID is pre-stored in an IoT database. The program may further comprise a program code for automatically generating a username and a random string as a password for the device based upon the device ID when the device ID is absent from the IoT database. The username and the password may be generated without a user input. The program may further comprise a program code for transmitting the username and the password to the device and to an external device. The program may further comprise a program code for facilitating the device for establishing a communication with the IoT platform based on the username and the password, thereby provisioning the device over the Internet of Things (IoT) platform.

In one implementation, a non-transitory computer readable medium embodying a program executable in a computing device for provisioning a device over an Internet of Things (IoT) platform is disclosed. The program may comprise a program code for receiving a connection request and a device identification (ID) from a device. The program may further comprise a program code for determining whether the device ID is pre-stored in an IoT database. The program may further comprise a program code for automatically generating a new random string as a new password for the device based upon the device ID when the device ID is absent from the IoT database. The new password may be generated without a user input. The program may further comprise a program code for transmitting the username and the new password to the device and to an external device. The program may further comprise a program code for facilitating the device for establishing a communication with the IoT platform based on the username and the new password, thereby provisioning the device over the Internet of Things (IoT) platform.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of an Internet of Things (IoT) server for provisioning a device over an IoT platform, in accordance with an embodiment of the present subject matter.

FIGS. 2a and 2b jointly illustrate a flowchart showing a method for provisioning a device over an Internet of Things (IoT) platform, in accordance with an embodiment of the present subject matter.

### DETAILED DESCRIPTION

A system and a method for provisioning a device over an IoT platform are described in the present subject matter. In one embodiment, a device seeking connection over the IOT platform may transmit a connection request to an IoT server. The IoT server may receive the connection request and a device identification (ID) from the device. The device ID may be unique for each device and may help the device to get identified by the IoT server. The IoT server may check whether the device ID is stored in an IoT database of the IoT server, wherein the IoT database may store device ID's of certain recognized devices. The recognized devices may be understood as devices which have previously communicated with the IoT server.

In one embodiment, the device ID may be absent in the IoT database. In this embodiment, it may be understood that the device is attempting to communicate with the IoT server for the first time. Subsequently, the IoT server may automatically generate a username and a password for the device based upon the device ID of the device. The password generated by the IoT server may be a random string. Further, the IoT server may transmit the username and the password to the device and to an external device. The external device may be one of an Extensible Messaging and Presence Protocol (XMPP) server or a Message Queue Telemetry Transport (MQTT) server. In one embodiment, the device may be authenticated, based upon the username and password, by the IoT server for establishing a communication with other devices present on the IoT platform. However, in another embodiment, the device may be authenticated, based upon the username and password, by the external device for establishing a communication with other devices on the IoT platform.

In another embodiment, the device ID may be present in the IoT database. In this embodiment, it may be understood that the device may have previously communicated with the IoT server. The IoT server may thus identify username of the device. Post that, the IoT server may automatically generate a new password for the device. The new password may be generated without a user input. The new password may be a new random string. The IoT server may transmit the username and the new password to the device and to the external device. Based upon the username and the new password, the device may be authenticated using two different approaches. In a first approach, the device may be authenticated by the IoT server for establishing a communication with the other devices connected over the IoT platform. In a second approach, the device may be authenticated by the external device for establishing a communication with the IoT platform.

While aspects of described IoT server and method for provisioning a device over an Internet of Things (IoT) platform may be implemented in any number of different computing systems, environments, and/or configurations, the embodiments are described in the context of the following system.

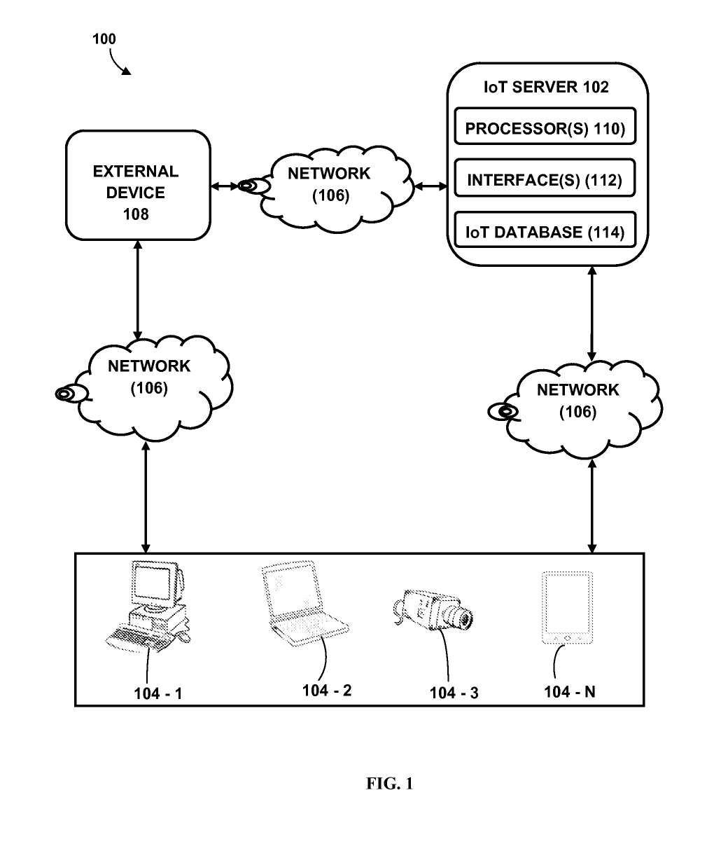

Referring to FIG. 1, an IoT server 102 for provisioning a device over an Internet of Things (IoT) platform is shown, in accordance with an embodiment of the present subject matter. In one embodiment, the IoT server 102 may receive a connection request and a device identification (ID) from a device 104. The IoT server 102 may determine whether the device ID is pre-stored in an IoT database 114. In an embodiment, the device ID may not be present in the IoT database 114. The IoT server 102 may thus automatically generate a username and a password for the device 104. Subsequently, the IoT server 102 may transmit the username and the password to the device 104 and an external device 108. The external device 108 may authenticate the device 104 for provisioning the device 104 over the IoT platform. Further, the external device 108 may authenticate the device 104 based on the username and the password. In another embodiment, the device ID of the device 104 may be present in the IoT database 114. In this embodiment, the IoT server 102 may identify the username of the device. The IoT server 102 may then automatically generate a new password for the device 104. Subsequently, the IoT server 102 may transit the username and the new password to the device 104 and the external device 108. Further, the external device 108 may provision the device 104 over the IoT platform by authenticating the device 104 based on the username and the new password.

Although the present subject matter is explained considering that the IoT server 102 is implemented for provisioning a device over an IoT platform, it may be understood that the IoT server 102 may also be implemented in a variety of computing systems, such as a laptop computer, a desktop computer, a notebook, a workstation, a mainframe computer, a server, a network server, and the like. In one embodiment, the IoT server 102 may be implemented in a cloud-based environment. It will be understood that the IoT server 102 may be accessed by one or more devices 104-1, 104-2 . . . 104-N, collectively referred to as a device 104 hereinafter, or applications residing on the device 104. Examples of the device 104 may include, but are not limited to a portable computer, a personal digital assistant, a handheld device, a digital camera, a smart phone, a tablet, a notepad, a laptop computer, a notebook, a workstation, a mainframe computer, a server, a network server, and other devices that may be connected over the IoT platform. The device 104 may be used in a field of medicine, automotive industry, and consumer electronics for accessing the IoT server 102. The devices 104 are communicatively coupled to the IoT server 102 through a network 106.

In one implementation, the network 106 may be a wireless network, a wired network or a combination thereof. The network 106 can be implemented as one of the different types of networks, such as intranet, local area network (LAN), wide area network (WAN), the Internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

Referring again to FIG. 1, the IoT server 102 is illustrated in accordance with an embodiment of the present subject matter. In one embodiment, the IoT server 102 may include at least one processor 110, input/output (I/O) interfaces 112, and an IoT database 114. Further, the at least one processor 110 may be implemented as one or more microprocessors, microcomputers, microcontrollers, digital signal processors, central processing units, state machines, logic circuitries, and/or any devices that manipulate signals based on operational instructions. Among other capabilities, the at least one processor 110 is configured to fetch and execute computer-readable instructions stored in the IoT database 114.

The I/O interfaces 112 may include a variety of software and hardware interfaces, for example, a web interface, a graphical user interface, and the like. The I/O interfaces 112 may allow the IoT server 102 to interact with a user directly. Further, the I/O interfaces 112 may enable the IoT server 102 to communicate with other computing devices, such as web servers and external data servers (not shown). The I/O interfaces 112 can facilitate multiple communications within a wide variety of networks and protocol types, including wired networks, for example, LAN, cable, etc., and wireless networks, such as WLAN, cellular, or satellite.

The IoT database 114 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

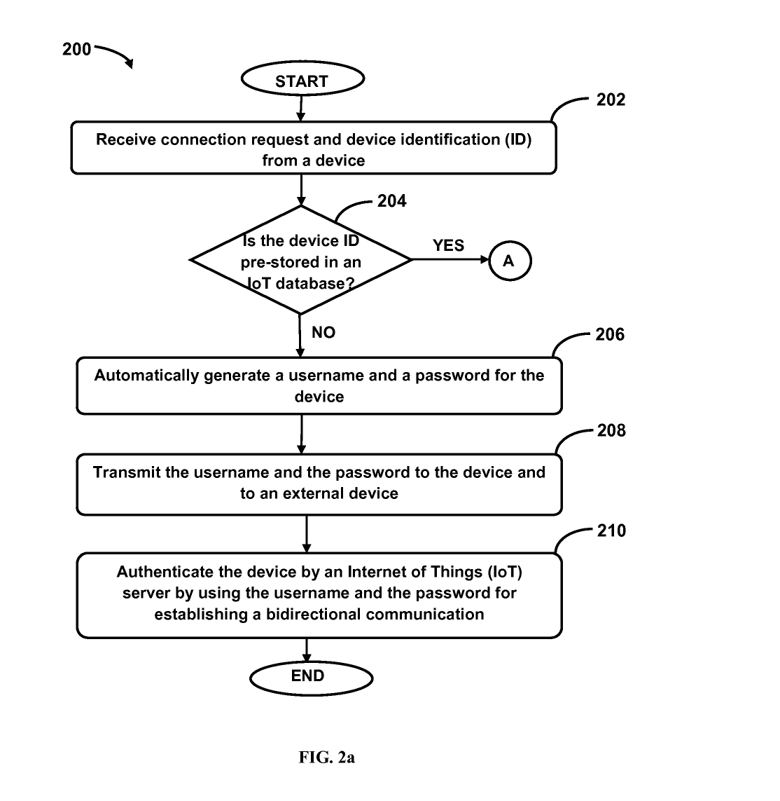

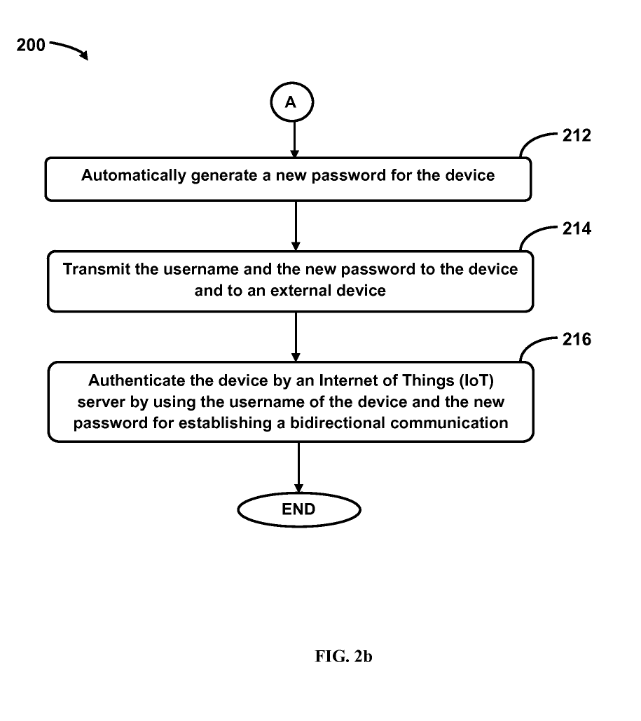

Referring now to FIG. 2, the method for provisioning a device 104 over an Internet of Things (IoT) platform is shown, in accordance with an embodiment of the present subject matter. The method 200 may be described in the general context of computer executable instructions. Generally, computer executable instructions can include routines, programs, objects, components, data structures, procedures, modules, functions, etc., that perform particular functions or implement particular abstract data types. The method 200 may also be practiced in a distributed computing environment where functions are performed by remote processing devices that are linked through a communications network. In a distributed computing environment, computer executable instructions may be located in both local and remote computer storage media, including memory storage devices.

The order in which the method 200 is described is not intended to be construed as a limitation, and any number of the described method blocks can be combined in any order to implement the method 200 or alternate methods. Additionally, individual blocks may be deleted from the method 200 without departing from the spirit and scope of the subject matter described herein. Furthermore, the method can be implemented in any suitable hardware, software, firmware, or combination thereof. However, for ease of explanation, in the embodiments described below, the method 200 may be considered to be implemented in the above described IoT server 102.

In one implementation, the device 104 may be connected to the network 106. The device 104 may be identified over the network 106 by the device identification (ID) of the device 104. The device ID may be unique for the device 104. For an example, the device ID may be one of an International Mobile Station Equipment Identity (IMEI) number, an Electronic serial number (ESN), an Electronic Product Code (EPC), a Radio Frequency Identification (RFID) tag code, a Media Access Control (MAC) address, or an Internet Protocol (IP) address. Further, the IP address may belong to a version 4 (IPv4) or a version 6 (IPv6) of the IP address.

In an embodiment, the device 104 may be pre-programmed to store an Uniform Resource Locator (URL) of the Internet of Things (IoT) server 102. The IoT server 102 may be programmed for managing the Internet of Things (IoT). The device 104 may transmit a connection request to the IoT server 102 through the network 106. The device 104 may use a Representational State Transfer (REST) web service Interface with a Simple Object Access Protocol (SOAP) for transmitting the connection request. Further, the device 104 may transmit the connection request over a Hypertext Transfer Protocol Secure (HTTPS) protocol for managing a secure connection. Also, the device 104 may transmit the device ID along with the connection request to the IoT server 102.

At step 202, the IoT server 102 may receive the connection request and the device ID of the device 104. Subsequently, the IoT server 102 may authenticate the connection request of the device 104. The IoT server 102 may authenticate the connection request based on the device ID. Further, the IoT server 102 may utilize an application name and a version of the application running on the device 104, for authenticating the connection request. The application name and the version of the application may be pre-stored in the IOT server 114. The IoT server 102 may transmit an error code to the device 104 while the authentication of the connection request fails. Further, the IoT server 102 may move on to step 204 upon a successful authentication of the connection request. Subsequent to the successful authentication of the connection request, the IoT server 102 may determine, at the step 204, whether the device ID is pre-stored in the IoT database 114. The IoT database 114 may be programmed to store device ID's of the devices that may have previously communicated with the IoT server 102.

In an embodiment, the device ID may not be present in the IoT database 114. The IoT server 102 may thus identify the device 104 for attempting to establish a communication with the IoT server 102 for the first time. Subsequently, the IoT server 102 may automatically generate the username and the password for the device 104, at step 206. The IoT server 102 may generate the username and the password without a user input. For an example, the username may be generated using a below mention approach,
Username=device ID+@+domain

Here, domain may indicate a category or a type of the device 104. Further, the IoT server 102 may generate a random string as a password for the device 104. The random string may comprise alphanumeric characters and symbols.

Post generating the username and the password, the IoT server 102 may transmit the username and the password to the device 104 and an external device 108, at step 208. The external device 108 may store the username and the password corresponding to the username. Subsequent to receiving the username and the password, the device 104 may communicate with the IoT server 102 through the external device 108.

In one embodiment, the external device 108 may use an Extensible Messaging and Presence Protocol (XMPP) protocol for establishing a bidirectional communication between the device 104 and the IoT server 102. The external device 108 may thus be identified as an XMPP server. The XMPP protocol may allow a bidirectional communication between the device 104 and the XMPP server without using an IP address of the device 104. Instead, the device ID of the device 104 may be used for identification of the device 104 by the XMPP server. The XMPP server may authenticate the device 104, at step 210, by matching the username and the password provided by the device 104 with the username and the password stored with the XMPP server. Post authentication of the device 104, the XMPP server may establish a bidirectional communication between the device 104 and the IoT server 102. The IoT server 102 may include other devices connected with the IoT server 102. Thus, the IoT server 102 may provide bidirectional connectivity between the device 104 and the other devices in an above described manner.

In another embodiment, the external device 108 may use a Message Queue Telemetry Transport (MQTT) protocol for providing a connection between the device 104 and the IoT server 102. The external device 108 may thus be identified as a MQTT server. The device 104 may communicate with the MQTT server upon authentication by the MQTT server. MQTT is a publish-subscribe based protocol and thus uses the username as a broker topic ID. The broker topic ID may also be identified as a message broker. The devices connected over the IoT may be required to be registered with the message broker. The device 104 may transfer data to the MQTT server for communicating with the other devices connected over the IoT. The MQTT server may store the data using the message broker. Further, the MQTT server may classify the data into classes. The devices connected over the IoT may be subscribed to at least one class of the classes. Further, the message broker of the MQTT server may transmit the data belonging to the at least one class subscribed by the device 104. Further, the data may be transmitted to the other devices registered with the message broker of the MQTT server.

In an embodiment, the device ID may be present in the IoT database 114. In this embodiment, the IoT server 102 may move on step 212. The IoT server 102 may thus identify that the device 104 may have previously established a communication with the IoT server 102. Thus, the IoT server 102 may identify the username of the device. Subsequently, the IoT server 102 may automatically generate a new password for the device 104. The IoT server 102 may generate the new password without a user input, at the step 212. The IoT server 102 may generate a new random string as the new password for the device 104. The new random string may comprise of alphanumeric characters and symbols.

Post generating the new password, the IoT server 102 may transmit the username and the new password to the device 104 and the external device 108, at step 214. The username of the device 104 may already be stored in the external device 108. The external device 108 may update the new password corresponding to the username of the device 104. Subsequent to updating the new password, the device 104 may communicate the IoT server 102 through the external device 108. The external device 108 may authenticate the device 104, at step 216, based on the username and the new password of the device. Further, the external device 108 may authenticate the device 104 and may provide a bidirectional connection with the IoT server 102 in an above described manner, as explained at the step 210.

Post authentication by the external device 108, the device 104 may collect usernames of other device from the external device 108. Further, the device 104 may collect the usernames without any user input. The device 104 may store the usernames of the other devices for creating a buddy list. The device 104 may use the usernames present in the buddy list for communicating with the other devices. The device 104 may communicate with the other devices based on business rules defined by an administrator. The business rules may be defined over the external device 108 and the IoT server 102. The device may also add a username of an administrator of the external device 108 in the buddy list. Thus, the device 104 may be provisioned over the IoT in an above described manner.

The above description explains about automating the process of identifying and registering the devices over the IoT platform. Further, the devices automatically create the buddy list comprising usernames of the other devices. The buddy list also comprises username of the administrator of the external device providing communication between the device and the IoT server. Thus, automatic provisioning of the devices over the IoT saves time and effort.

Although implementations for method and IoT server 102 for provisioning a device over an Internet of Things (IoT) platform have been described in language specific to structural features and/or methods, it is to be understood that the appended claims are not necessarily limited to the specific features or methods described. Rather, the specific features and methods are disclosed as examples of implementations for provisioning a device over and the Internet of Things (IoT) platform.

What is claimed is:

1. A method for provisioning a device over an Internet of Things (IoT) platform, the method comprising:
receiving, by a processor, a connection request and a device identification (ID) from a device;
determining, by the processor, whether the device ID is pre-stored in an IoT database;
automatically generating, by the processor, a username and a random string as a password for the device based upon the device ID when the device ID is absent from the IoT database, wherein the username and the password are generated without a user input;
transmitting, by the processor, the username and the password to the device and to an external device; and
facilitating, by the processor, the device for establishing a communication with the IoT platform based on the username and the password, thereby provisioning the device over the Internet of Things (IoT) platform.

2. The method of claim 1, wherein the external device is one of an Extensible Messaging and Presence Protocol (XMPP) server or a Message Queue Telemetry Transport (MQTT) server.

3. The method of claim 2, wherein the XMPP server enables a bidirectional communication between the device and the IoT platform based upon an XMPP protocol, wherein the XMPP protocol allows the device and the IoT to communicate without an Internet Protocol (IP) address of the device.

4. The method of claim 1, further comprising adding the device to a buddy list stored in the IoT database based upon the username and the password.

5. The method of claim 2, further comprising generating a Broker Topic ID for enabling communication between the device and the IoT platform by using the MQTT server.

6. A method for provisioning a device over an Internet of Things (IoT) platform, the method comprising:
receiving, by a processor, a connection request and a device identification (ID) from a device;
determining, by the processor, whether a username of the device ID is pre-stored in a IoT database;
automatically generating, by the processor, a new random string as a new password for the device when the username of the device ID is present in the IoT database, wherein the new password is generated without a user input;
transmitting, by the processor, the username and the new password to the device and to an external device; and
facilitating, by the processor, the device for establishing a communication with the IoT platform based on the username and the new password, thereby provisioning the device over the Internet of Things (IoT) platform.

7. A system for provisioning a device over an Internet of Things (IoT) platform, the system comprising:
a processor; and
a memory coupled to the processor, wherein the processor is capable for executing programmed instructions stored in the memory to:
receive a connection request and a device identification (ID) from a device;
determine whether the device ID is pre-stored in a IoT database;
automatically generate a username and a random string as a password for the device based upon the device ID when the device ID is absent from the IoT database, wherein the username and the password are generated without a user input;
transmit the username and the password to the device and to an external device; and
facilitate the device for establishing a communication with the IoT platform based on the username and the password, thereby provisioning the device over the Internet of Things (IoT) platform.

8. The system of claim 7, wherein the external device is one of an Extensible Messaging and Presence Protocol (XMPP) server or a Message Queue Telemetry Transport (MQTT) server.

9. The system of claim 8, wherein the XMPP server enables a bidirectional communication between the device and the IoT platform based upon an XMPP protocol, wherein the XMPP protocol allows the device and the IoT to communicate without an Internet Protocol (IP) address of the device.

10. The system of claim 7, further comprising adding the device to a buddy list stored in the IoT database based upon the username and the password.

11. The system of claim 8, further comprising generating a Broker Topic ID for enabling communication between the device and the IoT platform by using the MQTT server.

12. A system for provisioning a device over an Internet of Things (IoT) platform, the system comprising:
a processor; and
a memory coupled to the processor, wherein the processor is capable for executing programmed instructions stored in the memory to:
receive a connection request and a device identification (ID) from a device;
determine whether a username of the device ID is pre-stored in a IoT database;
automatically generate a new random string as a new password for the device when the username of the device ID is present in the IoT database, wherein the new password is generated without a user input;
transmit the username and the new password to the device and to an external device; and
facilitate the device for establishing a communication with the IoT platform based on the username and the new password, thereby provisioning the device over the Internet of Things (IoT) platform.

13. A non-transitory computer readable medium embodying a program executable in a computing device for provisioning a device over an Internet of Things (IoT) platform, the program comprising:
a program code for receiving a connection request and a device identification (ID) from a device;
a program code for determining whether the device ID is pre-stored in a IoT database;
a program code for automatically generating a username and a random string as a password for the device based upon the device ID when the device ID is absent from the IoT database, wherein the username and the password are generated without a user input;
a program code for transmitting the username and the password to the device and to an external device; and
a program code for facilitating the device for establishing a communication with the IoT platform based on the username and the password, thereby provisioning the device over the Internet of Things (IoT) platform.

14. A non-transitory computer readable medium embodying a program executable in a computing device for provisioning a device over an Internet of Things (IoT) platform, the program comprising:
a program code for receiving a connection request and a device identification (ID) from a device;
a program code for determining whether a username of the device ID is pre-stored in a IoT database;
a program code for automatically generating a new random string as a new password for the device when the username of the device ID is present in the IoT database, wherein the new password is generated without a user input;
a program code for transmitting the username and the new password to the device and to an external device; and
a program code for facilitating the device for establishing a communication with the IoT platform based on the username and the new password, thereby provisioning the device over the Internet of Things (IoT) platform.
